(19) United States
(12) Patent Application Publication
(10) Pub. No.: US 2006/0255129 A1
(43) Pub. Date: Nov. 16, 2006

(54) Secure room occupancy monitoring system and method

(76) Inventor: Craig Griffiths, Holliston, MA (US)

Correspondence Address: Brian M. Dingman, Esq.;Mirick, O'Connell, DeMallie & Lougee, 1700 West Park Drive, Westborough, MA, 01581, US

(21) Appl. No.: 11/357,674

(22) Filed: Feb. 17, 2006

Related U.S. Application Data
(60) Provisional application No. 60/657,674, filed on Mar. 1, 2005.

(51) Int. Cl. G06K 5/00

(52) U.S. Cl. 235/382

(57) ABSTRACT

A system and method for providing visual and/or aural notification to the last authorized user to leave a secure area, in which access to the area is based on an identification system that generates a signal when an authorized user entering or leaving the area has been identified. A counter, responsive to signals generated by the identification system, keeps track of the number of authorized users that have been authorized by the identification system to enter the area but have not yet been authorized by the identification system to leave the area. A warning device, responsive to the counter, generates a visual and/or aural message when the last person is authorized by the identification system to leave the area.

### CROSS REFERENCE TO RELATED APPLICATION

This application claims priority of Provisional application Ser. No. 60/657,674, filed on Mar. 1, 2005.

### FIELD OF THE INVENTION

This invention relates to monitoring a secure area to help ensure proper tracking of the occupants and to help ensure that the area is properly secured once it is no longer being used.

### BACKGROUND OF THE INVENTION

Department of Defense (DoD) contractors who fulfill and manage highly classified DoD contracts must have in place security systems to control access to certain work areas. Rooms with classified documents must be secured, and access to such rooms must be controlled. The Department of Security Services (DSS) manages all breaches in security at all DoD contractor facilities. The DoD will levy fines for each violation associated with unsecured rooms, or unsecured classified documents within a secure area. If these violations begin to exceed a manageable level with no plan in place to improve or eliminate the violations, the DoD contractor is in jeopardy of losing the DoD contract. Accordingly, there are both security and economic-based reasons to control access to secure rooms.

### SUMMARY OF THE INVENTION

This invention helps to ensure that the last person who leaves a secure area follows the procedures to secure all documents and lock the area when he/she exits. The invention employs existing room access control systems that validate or deny access to an area based on a stored set of user ID parameters.

The invention comprises a counting system. The system intercepts granted access control data from an access control system that is already in place, and uses this “access granted” data signal to initiate an up or down count based on personnel entering or exiting the secure area. When the count reaches zero (meaning that the last person is leaving the secured area), the system triggers audible and/or illuminated message(s) to notify the person that he/she must follow the procedures for securing the area before exiting the area. The system can be network-based and have set-up parameters that are locally programmed, so that multiple systems can be monitored via a software package at a central security monitoring console/station.

The invention will greatly curtail breaches by reducing the security hours it takes to check each secure door. The task can be monitored from the security console and, based on an alarm, will direct the security guard to the area where there may be a breach. This security solution will allow users to expand the number of secure doors into an area, which will provide authorized employees easier access to their work areas. The invention will also allow security personnel to more efficiently manage these secure areas by using fewer security personnel and by realizing a reduction in the time required to check secure areas.

The invention features a system for providing human-perceptible aural notification to the last authorized user to leave a secure area, in which access to the area is controlled by an identification system that generates a signal when an authorized user entering or leaving the area has been identified, the system comprising a counter, responsive to signals generated by the identification system, for keeping track of the number of authorized users that have been authorized by the identification system to enter the area but have not yet been authorized by the identification system to leave the area, and logic, responsive to the counter, for causing the generation of a visual and/or aural message when the last authorized user is authorized by the identification system to leave the area.

The identification system may generate Wiegand pulses. The system may further comprise a lighted sign, in which case the system may still further comprise one or more relays that are fired by the logic to light the sign. The system may further comprise a voice-based aural message generator, in which case the system may still further comprise one or more relays that are fired by the logic to play the message.

Also featured is a method of providing human-perceptible aural notification to the last authorized user to leave a secure area, in which access to the area is controlled by an identification system that generates a signal when an authorized user entering or leaving the area has been identified. The method comprises the steps of, in response to signals generated by the identification system, storing the number of authorized users that have been authorized by the identification system to enter the area but have not yet been authorized by the identification system to leave the area, and causing the generation of a visual and/or aural message when the last authorized user is authorized by the identification system to leave the area.

The method may work with an identification system that generates Wiegand pulses. The visual message may be displayed on a lighted sign. The aural message may be generated by a voice-based aural message generator.

### BRIEF DESCRIPTION OF THE DRAWINGS

Other objects, features and advantages will occur to those skilled in the art from the following description of the preferred embodiments, and the accompanying drawings, in which:

FIG. 1 is a schematic block diagram of the preferred embodiment of the inventive system;

FIGS. 2A and 2B are flow charts of the preferred methodology used with the system of FIG. 1; and

FIG. 3 is a schematic block diagram of another version of the preferred embodiment of the inventive system.

### DETAILED DESCRIPTION OF THE PREFERRED EMBODIMENTS

The disclosure of Provisional application Ser. No. 60/683,674, filed on May 23, 2005 is incorporated herein by reference.

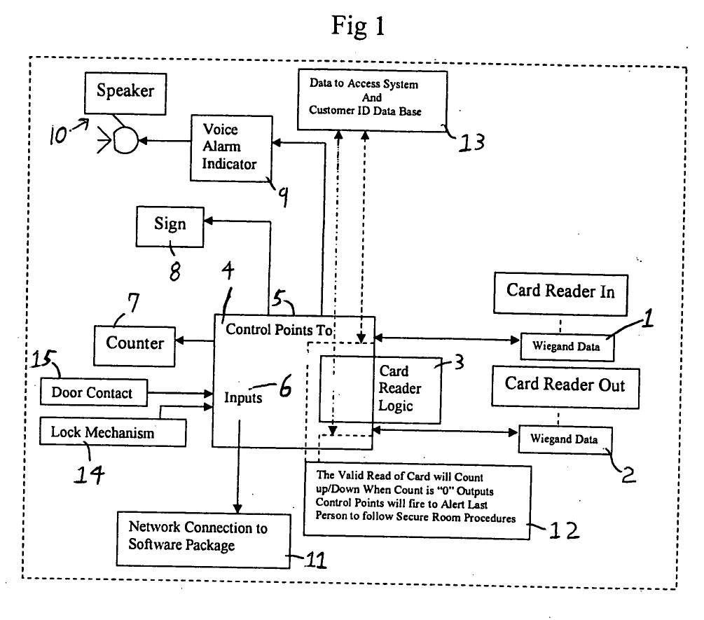

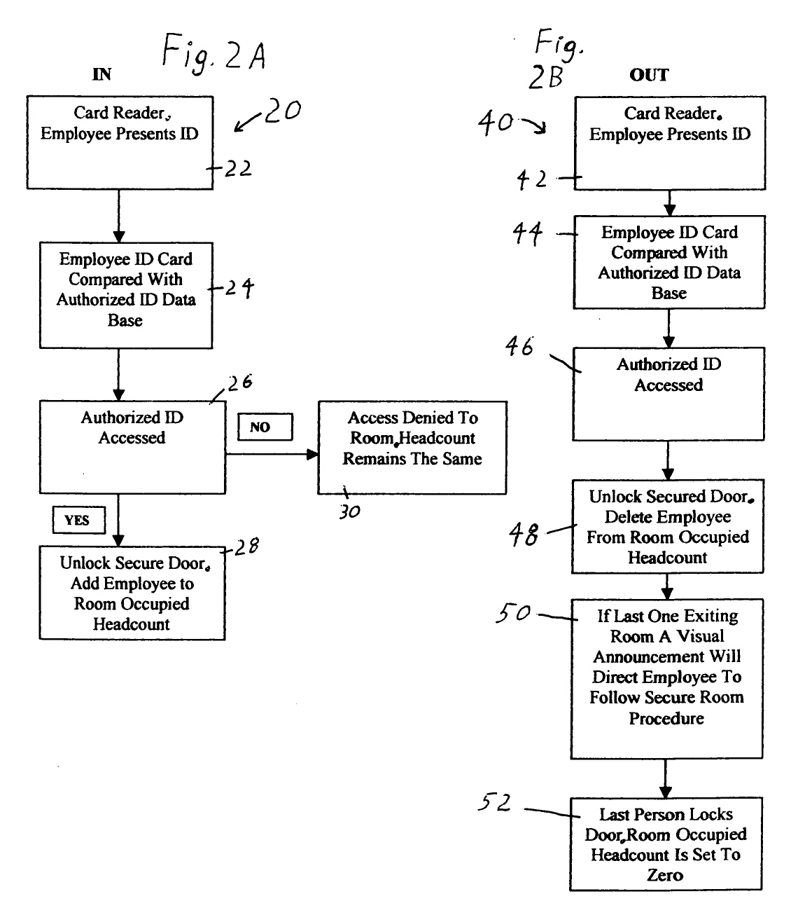

The preferred embodiment of the invention is disclosed in FIGS. 1 and 2. The following is a description of the numbered portions of FIG. 1. The inventive system is used with a pre-existing secure area access control system which generates a signal when an authorized user has been authorized to enter or leave the secure area.
1. Card Reader—“In”: Wiegand Data—A Wiegand pulse is generated and is sensed by a pickup coil in the room access (“In”) card reader. (“Wiegand” is a pulse-generating phenomenon in a special alloy embedded in a card. The wire is processed in such a way as to create two distinct magnetic regions in the same homogeneous piece of wire, referred to as a shell and a core. These two magnetic regions react differently to any applied magnetic field. The shell requires a strong magnetic field to reverse its magnetic polarity, whereas the core will revert under weaker field conditions. When the shell and core change to different polarity orientations, the Wiegand pulse is generated and is sensed by a pickup coil (the reader). Due to the complexity of manufacturing the Wiegand wire, Wiegand cards are virtually impossible to duplicate and remain one of the most secure access control technologies.) “Wiegand devices” are access control devices that employ this technology.
2. Card Reader—“Out”: Wiegand Data—Wiegand pulse is generated and is sensed by a pickup coil in the card reader.
3. Card Reader Logic—
4. Process Controller Logic—The logic for the invention, which can reside in a programmed computer. The computer can be located in a network.
5. Single Pole Double Throw Form-C Relay Outputs, Four Sets. Used for sign and voice alarm indicator.
6. Inputs from Door Contacts 15 and door Locking Mechanism 14. Resets system to zero to prevent an erroneous count.
7. Digital Up and Down Counting Display—displays the number of authorized users remaining in the secure area.
8. Custom-Illuminated Sign with Audio Indicator—Sign will light and will alert the last person leaving to follow security procedures for securing the area and locking the door upon exiting.
9. Voice Alarm Indicator—A storage for an aural message that duplicates the message on the illuminated sign. Note that it not necessary to have both a visible sign and an aural indicator, as one of these may suffice.
10. Speaker—Used to transmit alert message to last occupant of the area.
11. Network Connection to Customized Software Package—Software will indicate status and number of occupants in the secure area. Used for networked systems only (not necessary for stand-alone systems).
12. Advanced Processing Controller—When the controller receives a valid read of an ID Card, it will count up/down. When the count is “0”, control points 5 will fire to Custom Sign 8 and Voice Alarm Indicator 9, which will alert last occupant to follow “secure area” procedures.
13. Wiegand card reader(s) data will be sampled for use in the invention, while maintaining the integrity of the signal, which will continue uninterrupted to the existing access control system for normal processing.
14. Lock Mechanism—Upon verifying a card read the lock mechanism will unlock. The system will monitor the lock via a dry relay contact closure in parallel with the lock mechanism. This initial card read/lock input will cause the people counter display to increase or decrease by one digit.
15. Door Contact—Monitors the close or open status of the door. After the initial card read/input the door can be left open and additional card swipes will cause the people counter display to increase/decrease by one digit until the door is closed. This allows multiple people access to the room without closing and reopening the door when people access the room back-to-back.

Card reader logic 3 is detailed in FIGS. 2A and 2B, wherein FIG. 2A shows the logic 20 associated with the “in” control, and FIG. 2B shows the logic 40 associated with the “out” control. The people counter operates by reading the Wiegand card data on the “in” card reader and storing this information into the memory register within the counting control device (people counter) 12, causing an “up” count. When a matching data stream is presented via the “out” reader 2, the system will count “down” and eliminate the stored data from the memory register. This means that a person with a unique Wiegand card has passed the card through the “out” reader.

To eliminate an invalid up count at the in reader, the system will check for a reject pulse from the card access system (usually noted by a red LED output from the access control system to the Wiegand card reader). If access has been rejected (denied), the counter will not increment.

Logic 20, FIG. 2A, begins with step 22, in which the card is presented to the “in” card reader. The read of the card is compared with a database comprising authorized users, step 24. If authorized identification, step 26, is not successful, access is denied, step 30, and the people counter remains at its current level. If access is authorized, step 28, the door is unlocked and the people counter is incremented by one.

Logic 40, FIG. 2B, begins with step 42, in which the card is presented to the “out” card reader. The read of the card is compared with a database comprising authorized users, step 44. If access is authorized, step 46, the door is unlocked and the people counter is decremented by one, step 48. If the people counter is at zero (indicating that the person leaving is the last authorized person in the secure area), a visual and/or audible announcement directs the person to follow the predetermined procedure for securing the area, and the person takes the action(s), such as locking the door, steps 50 and 52. At this point, the headcount is set to zero.

The system is only as good as the personnel using it. The mere presence of the system will cause people to be more aware of the critical necessity to follow the security procedures established by the NISPOM (National Industrial Security Program Operating Manual) to secure the area. However, there will be human error situations—such as tailgating (the so-called “tailgate rule” prevents cardholders from following another cardholder through a door without using an access card. The system warns of a tailgate violation when a cardholder makes an access request from a location different from the area last entered), a forgotten card, or a possible misread or double read by the card reader—that will cause an erroneous count. Most of these errors can be eliminated by the use of anti-passback (anti-passback is a means of monitoring accesses by dividing a facility into regions to keep track of cardholder locations. Anti-passback violations include a cardholder passing back a card for another person to use, in which case the system receives two access requests for the same card, and tailgating, in which a cardholder follows another cardholder into a region, causing the system to receive an access request from an area where a cardholder is not known to be) in the card access system.

To ensure that a bad count will not last more than one day, the invention can incorporate a reset to zero input that can be activated by the output from the primary locking device or an output from the arming of the room's alarm system, either of which may occur when the last person has left the secure area. The invention may also include optional network control/monitoring software that will allow a centrally-located guard to monitor the count of all controlled areas. This guard will also have the capability of resetting a room to zero if he is certain the room is empty.

The invention can be used with security systems that do not use the Wiegand data format, as it only requires the presence of an access-control system that generates signals which can be accessed for use in the inventive system. Also, the invention can be used with access control systems that are not card based (e.g., systems that use biometric data). The invention can also comprise a proprietary access control system. The only requirement in this regard is that the invention is an adjunct to an access control system that generates data/signals (e.g. Wiegand data; door unlock signals) that can be accessed and used as inputs to the controller of the invention.

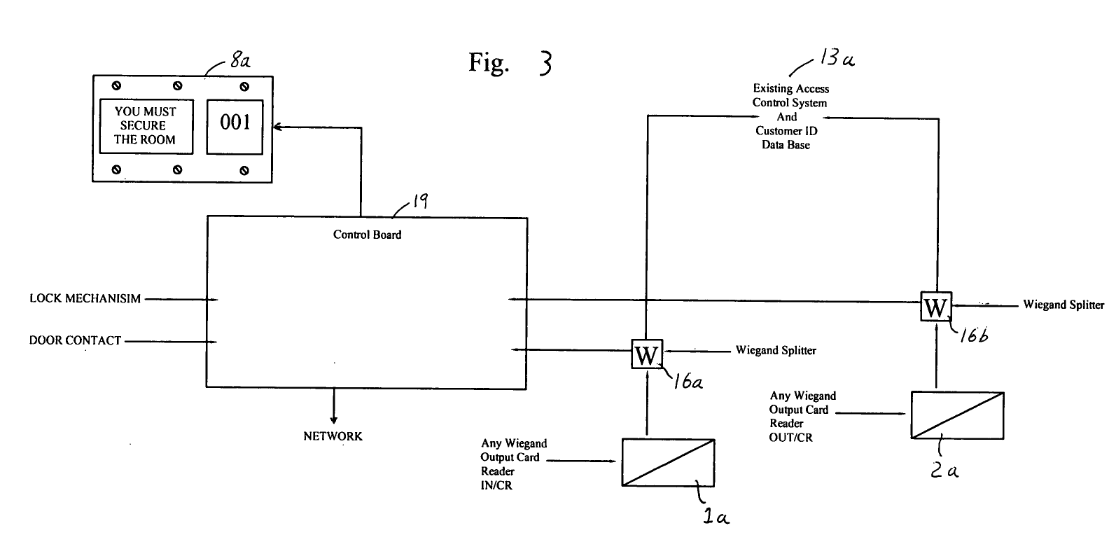

Another, slightly different embodiment, is shown in FIG. 3. This embodiment works as follows:
1. Card Reader—“In” (element 1a): Wiegand Data—A Wiegand pulse is generated and is sensed by a pickup coil in the room access (“In”) card reader. (“Wiegand” is a pulse-generating phenomenon in a special alloy embedded in a card. The wire is processed in such a way as to create two distinct magnetic regions in the same homogeneous piece of wire, referred to as a shell and a core. These two magnetic regions react differently to any applied magnetic field. The shell requires a strong magnetic field to reverse its magnetic polarity, whereas the core will revert under weaker field conditions. When the shell and core change to different polarity orientations, the Wiegand pulse is generated and is sensed by a pickup coil (the reader). Due to the complexity of manufacturing the Wiegand wire, Wiegand cards are virtually impossible to duplicate and remain one of the most secure access control technologies.) “Wiegand devices” are access control devices that employ this technology.
2. Card Reader—“Out” (element 2a): Wiegand Data—Wiegand pulse is generated and is sensed by a pickup coil in the card reader.
3. Wiegand splitters 16a, 16b are used to isolate Wiegand circuits where ground potential or other dissimilar voltages may interfere with data transmission
4. Control board 19—When the controller receives a valid read of an ID Card, it will count up/down. When the count is “0”, control points will fire to a custom illuminated sign 8a, preferably with an audio indicator. The sign can display the number of people left in the secure area, and can alert the last person leaving to follow security procedures for securing the area and locking the door upon exiting.
5. Wiegand card reader(s) data will be sampled for use in the invention, while maintaining the integrity of the signal, which will continue uninterrupted to the existing access control system 13a for normal processing.
6. Custom-Illuminated Sign with Audio Indicator and a Digital up and Down Counting Display 8a. Sign will light and will alert the last person leaving to follow security procedures for securing the area and locking the door upon exiting.
7. Lock Mechanism: Upon verifying a card read the lock mechanism will unlock. The system will monitor the lock via a dry relay contact closure in parallel with the lock mechanism. This initial card read/lock input will cause the people counter display to increase or decrease by one digit.
8. Door Contact: Monitors the close or open status of the door. After the initial card read/input the door can be left open and additional card swipes will cause the people counter display to increase/decrease by one digit until the door is closed. This allows multiple people access to the room without closing and reopening the door when people access the room back-to-back.
9. Network Connection to Customized Software Package—Software will indicate status and number of occupants in the secure area. Used for networked systems only (not necessary for stand-alone systems).

Although specific features of the invention are shown in some drawings and not others, this is for convenience only as features may be combined as would be apparent to those skilled in the art, in accordance with the invention.

Other embodiments will occur to those skilled in the art and are within the following claims.

What is claimed is:

1. A system for providing human-perceptible aural notification to the last authorized user to leave a secure area, in which access to the area is controlled by an identification system that generates a signal when an authorized user entering or leaving the area has been identified, the system comprising:
a counter, responsive to signals generated by the identification system, for keeping track of the number of authorized users that have been authorized by the identification system to enter the area but have not yet been authorized by the identification system to leave the area; and
logic, responsive to the counter, for causing the generation of a visual and/or aural message when the last authorized user is authorized by the identification system to leave the area.

2. The system of claim 1 wherein the identification system generates Wiegand pulses.

3. The system of claim 1 further comprising a lighted sign.

4. The system of claim 3 further comprising one or more relays that are fired by the logic to light the sign.

5. The system of claim 1 further comprising a voice-based aural message generator.

6. The system of claim 5 further comprising one or more relays that are fired by the logic to play the message.

7. A system for providing human-perceptible aural notification to the last authorized user to leave a secure area, in which access to the area is controlled by an identification system that generates Wiegand pulses when an authorized user entering or leaving the area has been identified, the system comprising:
a counter, responsive to Wiegand pulses generated by the identification system, for keeping track of the number of authorized users that have been authorized by the identification system to enter the area but have not yet been authorized by the identification system to leave the area;
a lighted sign;
a voice-based aural message generator; and
logic, responsive to the counter, for causing the generation of visual and aural messages when the last authorized user is authorized by the identification system to leave the area.

8. A method of providing human-perceptible aural notification to the last authorized user to leave a secure area, in which access to the area is controlled by an identification system that generates a signal when an authorized user entering or leaving the area has been identified, the method comprising:
in response to signals generated by the identification system, storing the number of authorized users that have been authorized by the identification system to enter the area but have not yet been authorized by the identification system to leave the area; and
causing the generation of a visual and/or aural message when the last authorized user is authorized by the identification system to leave the area.

9. The method of claim 8 wherein the identification system generates Wiegand pulses.

10. The method of claim 8 in which the visual message is displayed on a lighted sign.

11. The method of claim 8 in which the aural message is generated by a voice-based aural message generator.
